(19) United States
(12) Patent Application Publication
(10) Pub. No.: US 2021/0243201 A1
(43) Pub. Date: Aug. 5, 2021

(54) BLOCKCHAIN-BASED VERIFICATION FRAMEWORK

(71) Applicant: HEWLETT PACKARD ENTERPRISE DEVELOPMENT LP, Houston, TX (US)

(72) Inventors: Sebastien Tandel, Santa Clara, CA (US); Gustavo Bervian Brand, Porto Alegre (BR); Juliano Cardoso Vacaro, Porto Alegre (BR); Dorian Conde Langbeck, Porto Alegre (BR)

(21) Appl. No.: 16/973,240

(22) PCT Filed: Jun. 14, 2018
(86) PCT No.: PCT/US2018/037652

§ 371 Date: Dec. 8, 2020

(51) Int. Cl. H04L 29/06; H04L 9/32; H04L 29/08

(52) U.S. Cl. CPC H04L 63/12; H04L 2209/38; H04L 67/1097; H04L 9/3239

(57) ABSTRACT

A verification framework is decentralized by implementing a database of Known Good States through a blockchain and smart contracts. In this manner, the system may provide an open platform to attest the integrity of various components, which may originate from different vendors. As such, the system supports attestation for multi-vendor infrastructures. In some instances, the system may leverage crypto-economics to monetize the platform. For instance, verifiers may be rewarded according to terms of a smart contract implemented on the blockchain network. Moreover, in some instances, the components may be delivered via an immutable file system, such as the InterPlanetary File System (“IPFS”). The IPFS is a decentralized file system based on a peer-to-peer protocol, improving file distribution efficiency. Components stored using IPFS each are assigned a unique identifier, which is a hash digest composition over the file's blocks. Thus, any modifications to the components may be detected via hash comparisons.

### FIELD OF THE INVENTION

The field of the invention relates to a blockchain-based verification framework that stores hash files representing known good states of components in a distributed ledger for verification and distributing components through a decentralized file system for enhanced security.

### BACKGROUND OF THE INVENTION

Threats targeted at different levels of the software and hardware stack are becoming increasingly smarter given the current global scene with intelligence agencies leaks, cyber terrorism and commercial or state-level espionage. The supply chain is a target where hardware provided by any vendor can be tampered with in order to provide internal information from a given company or government. Due to recent and increasing cyber threats, there is an increasing need for robust and open management of supply chain integrity. However, the supply chain is a complex ecosystem where many partners are involved.

At the same time, consumers are increasingly demanding open architectures to meet these and other computer security challenges. This is in part driven by diverse, multi-vendor platforms including new and legacy hardware operating on consumer infrastructures. These and other problems exist with conventional verification systems.

### SUMMARY

The disclosure addressing these and other problems relates to a blockchain-based verification framework for managing a supply chain of components. In some implementations, a verification framework may be decentralized by implementing a database of Known Good States (KGS) through a blockchain and smart contracts. In this manner, the system may provide an open platform to attest the integrity of various components, which may originate from different vendors. As such, the system supports attestation for multi-vendor infrastructures. In some instances, the system may leverage crypto-economics to monetize the platform. For instance, verifiers may be rewarded according to terms of a smart contract implemented on the blockchain network. Moreover, in some instances, the components may be delivered via an immutable file system, such as the InterPlanetary File system (“IPFS”). The IPFS is a decentralized file system based on a peer-to-peer protocol, improving file distribution efficiency. Components stored using IPFS each are assigned a unique identifier, which is a hash digest composition over the file's blocks. Thus, any modifications to the components may be detected via hash comparisons.

The verification framework may leverage measured boot and remote attestation to compute chain hashes across different scenarios, including operating systems, applications, and other components pre-installed at servers, hardware with no operating system, network switches with dynamic software-defined networking (SDN) rules and configurations, and/or other components.

The system may generate a one-time computation of deterministic signatures such as hash digests of components. The deterministic signature may include an output of a deterministic function that will generate the same output given the same input. Given a different input, the deterministic function will generate a different output. In this manner, any changes to a component may be detected based on its deterministic signature. The hash digests may be stored on a distributed ledger of a blockchain network. A first agent at a component distributor (such as a software and/or hardware provider) may obtain the one-time pre-computation of the hash digests of each component. In some instances, the hash digest may be generated by the IPFS.

Once a component is installed on a consumer infrastructure, such as on a specific server, the state of the component may be attested to using the relevant deterministic signatures, which may be obtained from a distributed ledger of the blockchain network. A second agent at the consumer who implements the component into the consumer infrastructure may verify the integrity of the components. For example, the second agent may be implemented as a daemon or other process executing in the consumer infrastructure to perform a check of infrastructure components. The exchange of hash digests and other metadata between the first and second two agents may be mediated through a blockchain smart contract. As such, the system may facilitate trust between them. Additionally, the usage of blockchain smart contracts may generate a new marketplace to get the right economic conditions to incentivize these agents to willingly cooperate by being automatically rewarded to participate in the verification framework ecosystem.

In operation, in some instances, the system may receive a first information relating to a measurement of a component to be validated from a first node. The measurement may include a deterministic signature such as a hash digest of the component. The first information may be provided by a first blockchain node. The system may include receive a second information relating to the measurement of the component to be validated from a second node. The second information may be provided by a second blockchain node. The system may determine that the first information matches the second information. In this example, at least two nodes have verified that the deterministic signature is the same for the component, which may indicate a higher level of confidence that the signature is valid than if only one node verified the deterministic signature. The system may generate an entry including the first information in a distributed ledger. For example, the system may broadcast a blockchain transaction including the first information. Alternatively or additionally, the system may include generating a blockchain block and broadcasting the blockchain block to be added to the distributed ledger. In this manner, the deterministic signature may be stored on the distributed ledger. In some instances, the system may determine a deterministic signature and write the deterministic signature to the distributed ledger by broadcasting a blockchain transaction and/or broadcasting a blockchain block to be incorporated into the distributed ledger.

In some instances, a number of nodes that agree on the deterministic signature may be counted. The greater the number, the greater the confidence that the deterministic signature is correct. In some instances, as an incentive for the verifiers (such as the nodes that generated matching information for the measurement of the component), a reward may be apportioned to each of the nodes. Furthermore, the number may be provided to a consumer that wishes to verify the KGS of a component of the consumer's infrastructure. The number may indicate a level of confidence that the component is in a KGS.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates an example of a system of a blockchain-based verification framework for managing a supply chain of components, according to an implementation of the disclosure.

FIG. 2 illustrates an example of data flows in a blockchain-based verification framework for managing a supply chain of components, according to an implementation of the disclosure.

FIG. 3 illustrates an example of a process of a verification framework managing a supply chain of components, according to an implementation of the disclosure.

FIG. 4 illustrates an example of generating deterministic signature data for components using a trusted platform module in a blockchain-based verification framework, according to an implementation of the disclosure.

FIG. 5 illustrates an example of a process of recording known good states of a component via a blockchain, according to an implementation of the disclosure.

FIG. 6 illustrates an example of a process of verifying known good states of a component via a blockchain, according to an implementation of the disclosure.

FIG. 7 depicts a block diagram of an example computer system in which any of the embodiments described herein may be implemented.

### DETAILED DESCRIPTION OF THE INVENTION

The disclosure relates to decentralizing a verification framework by implementing a database of Known Good States (KGS) through a blockchain and smart contracts. In this manner, the system may provide an open platform to attest the integrity of various components, which may originate from different vendors. As such, the system supports attestation for multi-vendor infrastructures. In some instances, the system may leverage crypto-economics to monetize the platform. For instance, verifiers may be rewarded according to terms of a smart contract implemented on the blockchain network. Moreover, in some instances, the components may be delivered via an immutable file system, such as the InterPlanetary File system (“IPFS”). The IPFS is a decentralized file system based on a peer-to-peer protocol, improving file distribution efficiency. Components stored using IPFS each are assigned a unique identifier, which is a hash digest composition over the file's blocks. Thus, any modifications to the components may be detected via hash comparisons.

The verification framework may leverage measured boot and remote attestation to compute chain hashes across different scenarios, including operating systems, applications, and other components pre-installed at servers, hardware with no operating system, network switches with dynamic SDN rules and configurations, and/or other components.

The system may generate a one-time computation of deterministic signatures such as hash digests of components. The hash digests may be stored on a distributed ledger of a blockchain network. A first agent at a component distributor (such as a software and/or hardware provider) may obtain the one-time pre-computation of the hash digests of each component. In some instances, the hash digest may be generated by the IPFS.

Once a component is installed on a consumer infrastructure, such as on a specific server, the state of the component may be attested to using the relevant deterministic signatures, which may be obtained from a distributed ledger of the blockchain network. A second agent at the consumer who implements the component into the consumer infrastructure may verify the integrity of the components. For example, the second agent may be implemented as a daemon or other process executing in the consumer infrastructure to perform a check of infrastructure components. The exchange of hash digests and other metadata between the first and second two agents may be mediated through a blockchain smart contract. As such, the system may facilitate trust between them. Additionally, the usage of blockchain smart contracts may generate a new marketplace to get the right economic conditions to incentivize these agents to willingly cooperate by being automatically rewarded to participate in the verification framework ecosystem.

Various examples used herein will describe components as software packages such as operating systems and applications and associated metadata for illustration and not limitation. Other types of components, such as hardware, in a supply chain may be similarly tracked and verified as well. Furthermore, unless otherwise noted, the term “consumer” will be used to denote an entity who is provided with software packages or other components that can be verified using the system. Also as used herein, various examples will describe a hash digest such as an SHA-1 digest for a deterministic signature to represent a KGS. However, other deterministic signatures may be used as well.

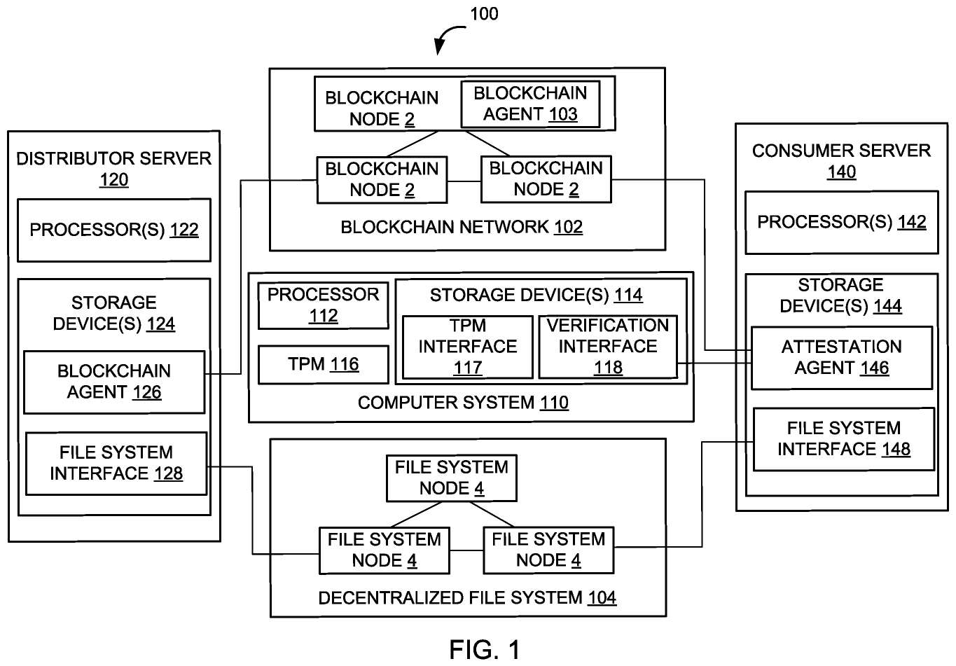

FIG. 1 illustrates an example of a system 100 of a blockchain-based verification framework for managing a supply chain of components, according to an implementation of the disclosure. System 100 may include a blockchain network 102, a decentralized file system 104, a computer system 110, a distributor server 120, a consumer server 140, and/or other components.

The blockchain network 102 may include one or more blockchain nodes 2 that are connected to one another using one or more connection protocols, including a peer-to-peer connection protocol. The particular number of, configuration of, and connections between the nodes may vary. The blockchain network 102 may include a distributed ledger that each node may store. The distributed ledger may include a series of blocks of data that reference at least another block, such as a previous block. In this manner, the blocks of data may be chained together.

Each blockchain node 2 may include a blockchain agent 103 that is configured to interact with other blockchain nodes 2 of the blockchain network 102. For example, the blockchain agent 103 may broadcast blockchain transactions for other nodes to process and “mine” into the distributed ledger. The blockchain agent 103 may also broadcast proposed blockchain blocks to be added to the distributed ledger. Still further, the blockchain agent 103 may be configured to generate consensus decisions by adding onto a proposed blockchain block to thereby incorporate the proposed blockchain block into the distributed ledger. The blockchain agent 103 may do so according to various blockchain protocols and specifications. It should be noted that the blockchain agent 103 may include the same functionality as the blockchain agent 126, and vice versa. It should be further noted that only one of the blockchain nodes 2 in FIG. 1 is illustrated with the blockchain agent 103 for clarity of the drawings. However, as previously noted, each of the blockchain nodes 2 may include a blockchain agent 103.

Generally speaking, A blockchain is a collection of blocks of data records that are connected together through the use of hashing. For example, when a new block is added to a blockchain, the new block includes a reference such as a hash of a prior block. In this manner, each additional block creates additional security for the validity of the entire blockchain. The blockchain may be implemented as a distributed ledger, which is a form of a decentralized database stored at each (or at least some of the) node participating in a blockchain (such as blockchain node 2).

The blockchain network 102 may be implemented as a public or private blockchain. In private blockchain implementations, blockchain nodes 2 may be assigned with certain permissions to access the distributed ledger. For example, some nodes 2 may have only read permissions while other blockchain nodes 2 will have both read and write permissions. In these implementations, each agent/blockchain node 2 may need to register with the blockchain network 102 and/or computer system 110 to use the system. In some instances, the computer system 110 may restrict access to the blockchain network 102, securing its privacy. For example, some blockchain agents 103 described herein may access only data pertaining to the agent via public-private key encryption. In this example, data on the private distributed ledger or a blockchain transaction relevant to a given blockchain agent 103 may be encrypted by the computer system 110 using the blockchain agent 103's public key such that only the blockchain agent 103's private key can decrypt its contents.

The decentralized file system 104 may include one or more file system nodes 4 that are connected to one another using one or more connection protocols, including a peer-to-peer connection protocol. The particular number of, configuration of, and connections between the nodes may vary. Each of the file system nodes 4 may store all or a portion of data, such as data related to components in the supply chain referred to herein. In some implementations, the decentralized file system 104 may be implemented as an IPFS. Various IPFS specifications are disclosed at: https://github.com/ipfs/specs, and are incorporated by reference in their entireties herein.

The computer system 110 may include or access one or more processors 112, one or more storage devices 114, a Trusted Platform Module (“TPM”) 116, and/or other components. The one or more storage devices 124 may store instructions that when executed on the one or more processors 112, programs them to perform various functions described herein. For example, the one or more storage devices 114 may store a TPM interface 117, a verification interface 118, and/or other instructions. The TPM interface 117 may permit users such as distributors and consumers to access the TPM 116. The verification interface 118 may receive and requests to verify a state of a component. For example, the verification interface 118 may receive a hash digest and/or component identifier from a consumer server 140. The computer system 110 may broadcast the request as a blockchain transaction. Third party verifiers, which may operate one or more nodes 2, may obtain the blockchain transaction and determine whether the hash digest matches what is stored in the distributed ledger. If so, the verifier may return an indication of the match (indicating that the component is in a KGS).

The TPM 116 may include a secure processor with one or more integrated cryptographic keys. Through the TPM 116, the computer system 110 may provide a secure environment for obtaining and assessing KGS of components being distributed by a distributor, which may operate the distributor server 120. For example, the computer system 110 may provide a host infrastructure that includes the TPM 116 and provides access to the secure environment provided by the TPM 116 to others, such as the distributor server 120, the consumer server 140, verifier nodes described herein, and/or other components. It should be noted that the TPM 116 may be hosted at the distributor infrastructure 220 and/or at the consumer infrastructure 240 as well.

The distributor server 120 may be used to build components, generate a hash digest for each component, broadcast the hash digest through the blockchain network 102 for storage in a decentralized KGS database, and distribute the component through the decentralized file system 104. For example, the distributor server 120 may include or access one or more processors 122, one or more storage devices 124, and/or other components.

The one or more storage devices may store a blockchain agent 126, a file system interface 128, and/or other instructions that program the one or more processors 122. The blockchain agent 126 may operate on a blockchain node 2. In other words, as will be described below, the distributor server 120 may interface with or operate a blockchain node 2. The file system interface 128 may provide components to the decentralized file system 104 for distribution to consumers.

The consumer server 140 may obtain the component from the decentralized file system 104, generate a hash digest of the component, and verify the KGS of the component based on the hash digest and the KGS database stored at the blockchain network 102. For example, the consumer server 140 may include or access one or more processors 142, one or more storage devices 144, and/or other components. The one or more storage devices may store an attestation agent 146, a file system interface 148, and/or other instructions that program the one or more processors 122. The attestation agent 146 may request that a particular component or set of components on the consumer infrastructure 240 be verified to ensure that it or they are in a KGS. To do so, the attestation agent 146 may generate a hash digest(s) of the component(s). In some instances, the attestation agent 146 may do so by accessing the TPM 106 to generate the hash digest(s). The attestation agent 146 may transmit a request to verify that the component(s) are in a KGS. For example, the attestation agent 146 may transmit the hash digest(s), and any component identifiers (from the decentralized file system 104), for verification. The attestation agent 146 may periodically verify the KGS of one or more components of the consumer infrastructure 240. For instance, the attestation agent 146 may be implemented as a daemon or other process of the consumer infrastructure 240. The file system interface 148 may obtain components from the decentralized file system 104. For instance, the consumer server 140 may access or otherwise execute a file system node 4 to read data from the decentralized file system 104.

In particular, the consumer server 140 may transmit a request including the hash digest to a verifier component, which determines whether or not the hash digest is contained in the KGS database. If so, the KGS of the component has been validated (also referred to herein as “verified”). If not, the component is not verified. In some instances, the number of blockchain nodes 2 of the blockchain network 102 that has independently confirmed that the hash digest of the component is valid may be provided along with the response to the request. A larger number of nodes 2 that confirmed the hash digest is typically associated with a greater level of confidence that the component inquired about is in a KGS. It should be noted that in the figures, although only one distributor infrastructure 220 and corresponding components is illustrated, multiple distributor infrastructures 220 may participate in the system 100, enabling multi-vendor consumer infrastructures to be verified in a KGS. Likewise, multiple consumer infrastructures 240 may participate to verify their infrastructures.

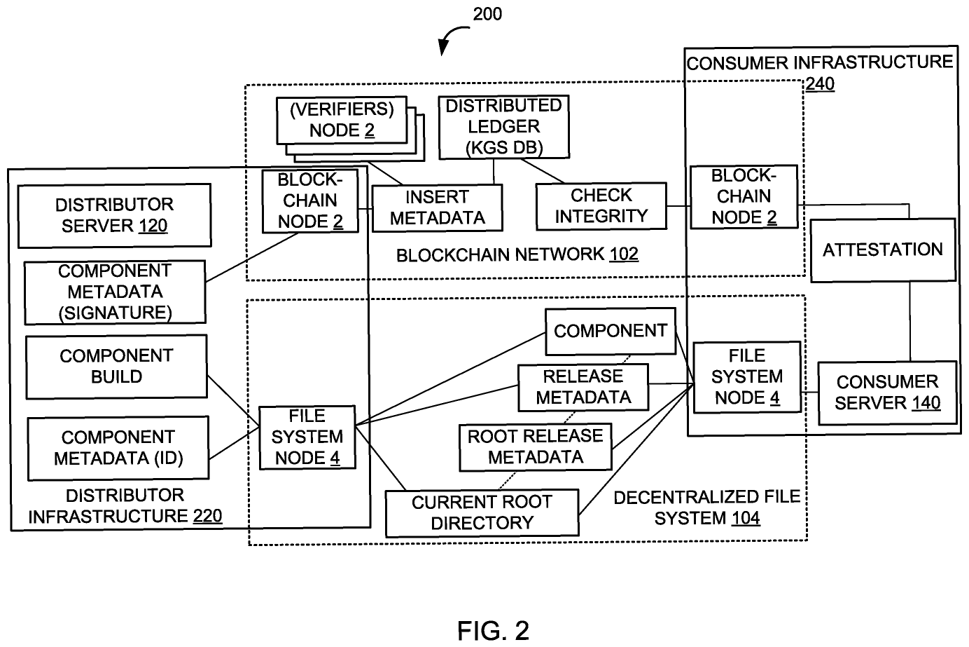

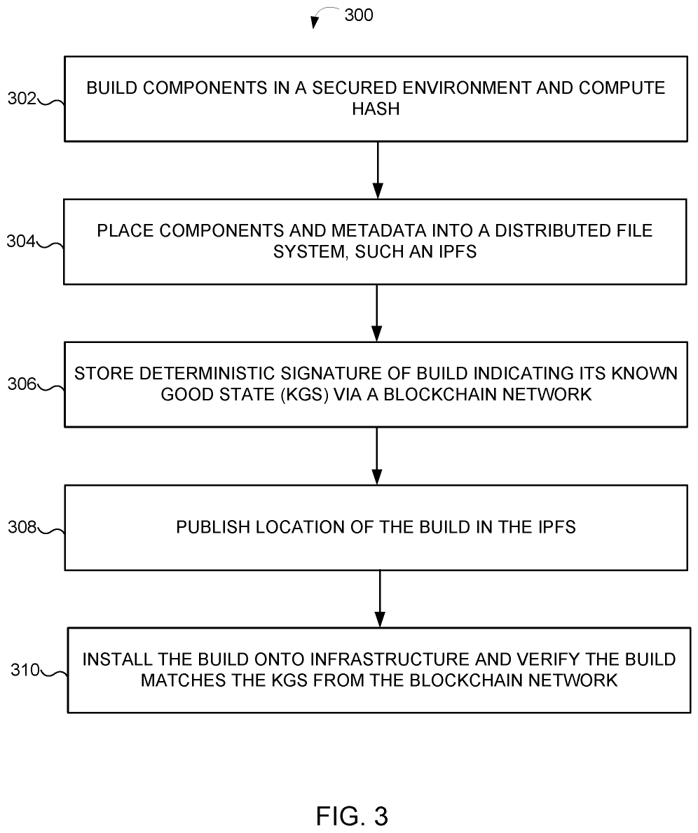

The following description will also refer to FIG. 2, which illustrates an example of data flows in a blockchain-based verification framework 200 for managing a supply chain of components and FIG. 3, which illustrates an example of a process 300 of a verification framework managing a supply chain of components. The distributor server 120 may be part of a distributor infrastructure 220 and the consumer server 140 may be part of a consumer infrastructure 240. The distributor infrastructure 220 may participate in the blockchain network 110 by operating a blockchain node 2 and may participate in the decentralized file system by operating a node 4. Likewise, the consumer infrastructure 240 may participate in the blockchain network 110 by operating a blockchain node 2 and may participate in the decentralized file system by operating a node 4. The consumer infrastructure 240 may include components from various vendors, making verification of the states of these components difficult without the use of system 100.

In an operation 302, through the TPM 116, a distributor may build a component and associated metadata in a secure environment. For instance, a distributor such as a vendor of the component may build the component via the TPM 116 for cryptographic keys management. In some instances, the TPM 116 may generate a hash digest for each file of the component.

In an operation 304, the distributor server 120 may use the file system interface 128 to place the component and metadata into the decentralized file system 104. In some instances, the file system interface 128 may operate on a node 4 of the decentralized file system 104. As such, the distributor server 120 may interface with or operate a node 4. In a particular example, the component and metadata may be placed into an IPFS via an IPFS node that is able to read and/or write files on the IPFS.

In some instances, the decentralized file system 104 may return a unique identifier for each component stored therein. In these instances, in an operation 306, the blockchain agent 126 may obtain the unique identifier for each component in the decentralized file system 104 and the hash digests from the TPM 116. The blockchain agent 126 may generate a blockchain transaction that includes the unique identifiers and hash digests, which may be stored in association with one another such that a unique identifier identifies a particular component and a hash digest represents a deterministic signature of the component identified by the unique identifier. In some instances, third party verifiers each operating a respective blockchain node 2 may operate to confirm one or more blockchain transactions and write them transaction into a blockchain block of the distributed ledger. In some instances, these verifiers may independently verify the authenticity of the data by generating hash digests of the relevant components to ensure that the broadcasted transaction includes the correct hash digest, which indicates that the component in the IPFS or other file system has not been tampered with or otherwise modified.

In an implementation, the system may facilitate a marketplace to monetize the system. Thus, an operator of the computer system 110 may monetize an open (blockchain-based) system, while incentivize stakeholders to participate in the marketplace. For example, a blockchain-based smart contract may be previously agreed upon by the stakeholders and implemented as an automated transaction with 1) a fee paid to add a transaction to the blockchain and 2) a financial transfer between two or more parties. The system may leverage the smart contracts to create a new marketplace, open to all software and hardware vendors (such as distributors 120) and their customers to provide a solution which can guarantee the integrity of their infrastructure. Due to smart contracts delegation, the system may provide a generic smart contract that routes the transaction to the right contract, depending on the vendor and partner involved. By doing so, a party's revenue stream is automatically generated by the execution of the smart contracts initiated by the integrity checks. For example, verifiers may be rewarded a fee for verifying deterministic signatures. Distributors may likewise be incentivized to use the system, not only to satisfy their consumers' demand for supply chain integrity, but also to be rewarded to use the system.

In an operation 308, the location of the component build may be published. For example, By using InterPlanetary Name System (which is a DNS-like service for IPFS), the distributor may publish at its IPNS address a pointer to the latest digest of the repository root folder, illustrated in FIG. 2 as “Current Root Directory.” The IPFS permits navigation through the subdirectories, such as the “Root Release Metadata,” “Release Metadata,” and “Component” subdirectories. In this manner, the component data and metadata may be obtained based on the IPNS address and pointer of the distributor.

In an operation 310, the build may be obtained from the decentralized file system 104, installed at the consumer infrastructure 240, and verified that the build is in a KGS. For instance, the consumer server 140 may request that one or more components be verified. In some instances, the request and/or results of the request may be broadcast to the blockchain network 102 as a blockchain transaction, which may be written to the distributed ledger. In this manner, the system may guarantee auditable transactions of any verification check.

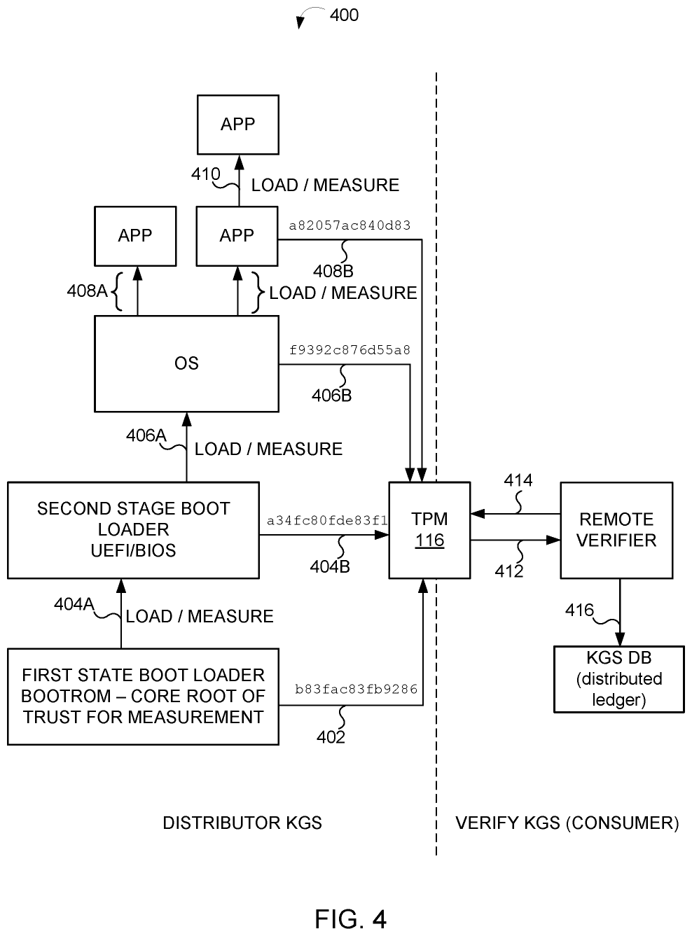

FIG. 4 illustrates an example of a dataflow 400 for generating deterministic signature data for components using a TPM 116 in a blockchain-based verification framework and verification using this data, according to an implementation of the disclosure. “Measurements” described with respect to FIG. 4 is meant to convey a deterministic signature that indicates a state of a component. If the component is altered, for example, the deterministic signature generated by, for example, a hash function, will also be altered.

In an operation 402, process 400 may include a measurement of a first state of a state boot loader, such as a measurement of the Boot ROM of a chip. The measurement, illustrated by the hash value “b83fac83fb9286,” may be generated in the TPM 116. This measurement may be stored in one or more Platform Configuration Registers (PCRs) of the TPM 116. The distributor or others may also store the measurement in the distributed ledger of the blockchain network 102.

In an operation 404A, process 400 may include loading and measuring the second state boot loader, such as a Unified Extensible Firmware Interface (“UEFI”) or Basic Input Output System (“BIOS”). In an operation 404B, process 400 may include storing the resulting measurement (e.g., “a34fc80fdeB3f1”) in one or more PCRs and/or the distributed ledger.

In an operation 406A, process 400 may include loading and measuring an operating system (“OS”). In an operation 406B, process 400 may include storing the resulting measurement (e.g., “f9392c876d55a8”) in one or more PCRs and/or the distributed ledger.

In an operation 408A, process 400 may include loading and measuring one or more applications (“APP”). In an operation 408B, process 400 may include storing the resulting measurement (e.g., “a82057ac840d83”) in one or more PCRs and/or the distributed ledger. In some instances, each measurement (such as from 402, 404B, 406B, and 408B) may be stored in a respective PCR, and therefore may be separately obtained from the TPM 116.

In an operation 410, process 400 may include loading and measuring one or more applications (“APP”) by another app. The process may continue so long as components whose KGS may be tracked and verified. As illustrated, a component may include multiple other sub-components, each of which may be measured to obtain a deterministic signature to track its KGS. As such, a KGS of each sub-component may be individually tracked as well as or instead of an overall deterministic signature for the component package as whole.

By using the TPM 116 and the distributed ledger, a distributor may identify a KGS (via deterministic signature measurement) of each component. Furthermore, even if sub-components are sourced from various vendors, the KGS of each sub-component may be identified as well. Because the deterministic signature is stored in the distributed ledger, once the component (and any sub-components—collectively, the “package”) is installed at a consumer infrastructure 240, the consumer may periodically verify that its package build is in a KGS.

For example, in an operation 412, process 400 may include providing a nonce to the TPM 116. In an operation 414, process 400 may include obtaining signed measurements from the TPM 116. In an operation 416, process 400 may include validating the signature and measurements based on the measurements stored in the distributed ledger storing the KGS database.

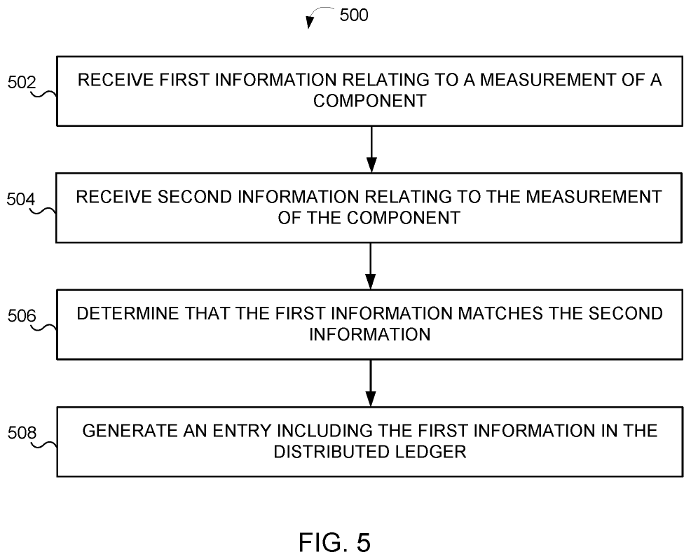

FIG. 5 illustrates an example of a process 500 of recording known good states of a component via a blockchain, according to an implementation of the disclosure. In an operation 502, process 500 may include receiving a first information relating to a measurement of a component to be validated from a first node. The measurement may include a deterministic signature such as a hash digest of the component. The first information may be provided by a first blockchain node.

In an operation 504, process 500 may include receiving a second information relating to the measurement of the component to be validated from a second node. The second information may be provided by a second blockchain node.

In an operation 506, process 500 may include determining that the first information matches the second information. In this example, at least two nodes have verified that the deterministic signature is the same for the component, which may indicate a higher level of confidence that the signature is valid than if only one node verified the deterministic signature.

In an operation 508, process 500 may include generating an entry including the first information in a distributed ledger. For example, process 500 may broadcast a blockchain transaction including the first information. Alternatively or additionally, process 500 may include generating a blockchain block and broadcasting the blockchain block to be added to the distributed ledger. In this manner, the deterministic signature may be stored on the distributed ledger. It should be noted that process 500 may determine a deterministic signature and write the deterministic signature to the distributed ledger by broadcasting a blockchain transaction and/or broadcasting a blockchain block to be incorporated into the distributed ledger.

In some instances, a number of nodes that agree on the deterministic signature may be counted. The greater the number, the greater the confidence that the deterministic signature is correct. In some instances, as an incentive for the verifiers (such as the nodes that generated matching information for the measurement of the component), a reward may be apportioned to each of the nodes.

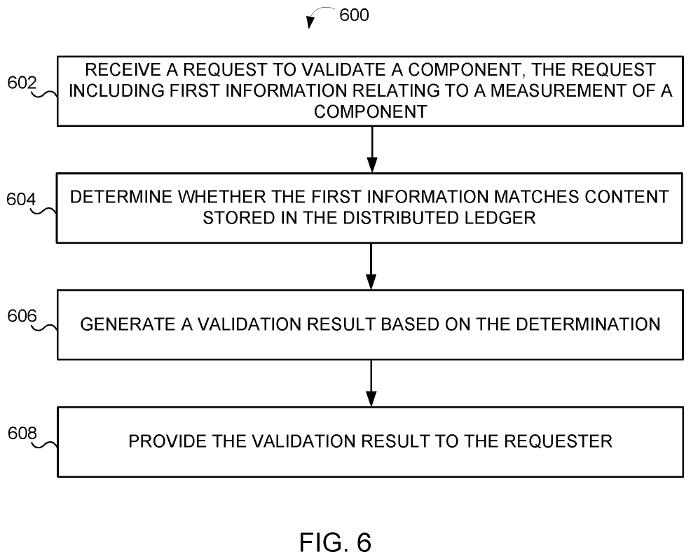

FIG. 6 illustrates an example of a process 600 of verifying known good states of a component via a blockchain, according to an implementation of the disclosure.

In an operation 602, process 600 may include receiving a request from a requester, the request comprising a first information relating to a measurement of a component to be validated

In an operation 604, process 600 may include determining whether the first information matches a content stored in a distributed ledger used to validate a plurality of components including the component. In an operation 606, process 600 may include generating a validation result indicating whether the first information matches the content stored in the distributed ledger. In an operation 608, process 600 may include providing the validation result to the requester.

Although illustrated in FIG. 1 as a single component, a computer system 110 may include a plurality of individual components (such as computer devices) each programmed with at least some of the functions described herein. Each of the one or more processors described herein may include one or more physical processors that are programmed by computer program instructions. The various instructions described herein are provided for illustrative purposes. Other configurations and numbers of instructions may be used, so long as the processor(s) 20 are programmed to perform the functions described herein.

Furthermore, it should be appreciated that although the various instructions are illustrated in FIG. 1 as being co-located within a single processing unit, in implementations in which processor(s) includes multiple processing units, one or more instructions may be executed remotely from the other instructions.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) may be programmed by one or more additional instructions that may perform some or all of the functionality attributed herein to one of the instructions.

The various instructions described herein may be stored in a storage device, which may comprise random access memory (RAM), read only memory (ROM), and/or other memory. The storage device may store the computer program instructions (such as the aforementioned instructions) to be executed by processor as well as data that may be manipulated by processor. Each of the described storage devices may comprise one or more non-transitory machine-readable storage media such as floppy disks, hard disks, optical disks, tapes, or other physical storage media for storing computer-executable instructions and/or data.

The components illustrated in FIG. 1 and other figures may be coupled to one another via a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1, as well as in other drawing figures, different numbers of entities than those depicted may be used. Furthermore, according to various implementations, the components described herein may be implemented in hardware and/or software that configure hardware.

The various processing operations and/or data flows depicted in FIG. 3 (and in the other drawing figures) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

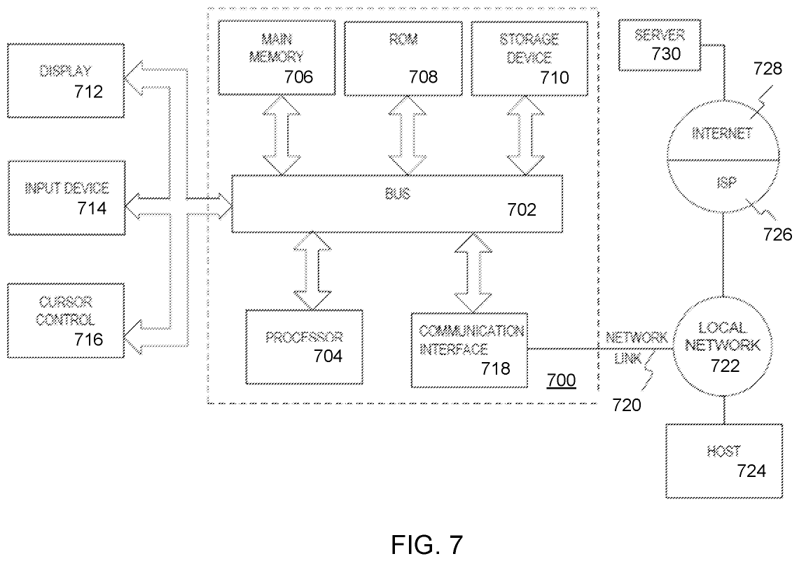

FIG. 7 depicts a block diagram of an example computer system 700 in which any of the embodiments described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a cathode ray tube (CRT) or LCD display (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 700 may include a user interface component to implement a GUI that may be stored in a mass storage device as executable software codes that are executed by the computing device(s). This and other components may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” as used herein, refers to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors. The components or computing device functionality described herein are preferably implemented as software components, but may be represented in hardware or firmware. Generally, the components described herein refer to logical components that may be combined with other components or divided into sub-components despite their physical organization or storage.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may retrieves and executes the instructions. The instructions received by main memory 706 may optionally be stored on storage device 710 either before or after execution by processor 704.

The computer system 700 also includes a communication interface 718 coupled to bus 702. Communication interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, network interface 718 may be a local area network (LAN) card to provide a data communication connection to a compatible LAN (or WAN component to communicated with a WAN). Wireless links may also be implemented. In any such implementation, network interface 718 sends and receives electrical, electromagnetic or optical signals that carry digital data streams representing various types of information.

A network link 720 typically provides data communication through one or more networks to other data devices. For example, a network link may provide a connection through local network to a host computer 724 or to data equipment operated by an Internet Service Provider (ISP) 726. The ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link and through communication interface 718, which carry the digital data to and from computer system 700, are example forms of transmission media.

The computer system 700 can send messages and receive data, including program code, through the network(s), network link and communication interface 718. In the Internet example, a server 730 might transmit a requested code for an application program through the Internet 728, the ISP 726, the local network 722 and the communication interface 718.

The received code may be executed by processor 704 as it is received, and/or stored in storage device 710, or other non-volatile storage for later execution.

Although the instant disclosure describes a blockchain-based verification framework, the framework can be implemented in any type of distributed ledger based systems. Blockchain is generally considered one example of distributed ledger. In this disclosure, blockchain and distributed ledger technology (“DLT”) may be used interchangeably.

Each of the processes, methods, and algorithms described in the preceding sections may be embodied in, and fully or partially automated by, code components executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Certain embodiments are described herein as including logic or a number of components, engines, or mechanisms. Engines may constitute either software engines (e.g., code embodied on a machine-readable medium) or hardware engines. A “hardware engine” is a tangible unit capable of performing certain operations and may be configured or arranged in a certain physical manner. In various example embodiments, one or more computer systems (e.g., a standalone computer system, a client computer system, or a server computer system) or one or more hardware engines of a computer system (e.g., a processor or a group of processors) may be configured by software (e.g., an application or application portion) as a hardware engine that operates to perform certain operations as described herein.

In some embodiments, a hardware engine may be implemented mechanically, electronically, or any suitable combination thereof. For example, a hardware engine may include dedicated circuitry or logic that is permanently configured to perform certain operations. For example, a hardware engine may be a special-purpose processor, such as a Field-Programmable Gate Array (FPGA) or an Application Specific Integrated Circuit (ASIC). A hardware engine may also include programmable logic or circuitry that is temporarily configured by software to perform certain operations. For example, a hardware engine may include software executed by a general-purpose processor or other programmable processor. Once configured by such software, hardware engines become specific machines (or specific components of a machine) uniquely tailored to perform the configured functions and are no longer general-purpose processors. It will be appreciated that the decision to implement a hardware engine mechanically, in dedicated and permanently configured circuitry, or in temporarily configured circuitry (e.g., configured by software) may be driven by cost and time considerations.

Accordingly, the phrase “hardware engine” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented engine” refers to a hardware engine. Considering embodiments in which hardware engines are temporarily configured (e.g., programmed), each of the hardware engines need not be configured or instantiated at any one instance in time. For example, where a hardware engine comprises a general-purpose processor configured by software to become a special-purpose processor, the general-purpose processor may be configured as respectively different special-purpose processors (e.g., comprising different hardware engines) at different times. Software accordingly configures a particular processor or processors, for example, to constitute a particular hardware engine at one instance of time and to constitute a different hardware engine at a different instance of time.

Hardware engines can provide information to, and receive information from, other hardware engines. Accordingly, the described hardware engines may be regarded as being communicatively coupled. Where multiple hardware engines exist contemporaneously, communications may be achieved through signal transmission (e.g., over appropriate circuits and buses) between or among two or more of the hardware engines. In embodiments in which multiple hardware engines are configured or instantiated at different times, communications between such hardware engines may be achieved, for example, through the storage and retrieval of information in memory structures to which the multiple hardware engines have access. For example, one hardware engine may perform an operation and store the output of that operation in a memory device to which it is communicatively coupled. A further hardware engine may then, at a later time, access the memory device to retrieve and process the stored output. Hardware engines may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein. As used herein, “processor-implemented engine” refers to a hardware engine implemented using one or more processors.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It will be appreciated that an “engine,” “system,” “data store,” and/or “database” may comprise software, hardware, firmware, and/or circuitry. In one example, one or more software programs comprising instructions capable of being executable by a processor may perform one or more of the functions of the engines, data stores, databases, or systems described herein. In another example, circuitry may perform the same or similar functions. Alternative embodiments may comprise more, less, or functionally equivalent engines, systems, data stores, or databases, and still be within the scope of present embodiments. For example, the functionality of the various systems, engines, data stores, and/or databases may be combined or divided differently.

“Open source” software is defined herein to be source code that allows distribution as source code as well as compiled form, with a well-publicized and indexed means of obtaining the source, optionally with a license that allows modifications and derived works.

The data stores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

As used herein, the term “or” may be construed in either an inclusive or exclusive sense. Moreover, plural instances may be provided for resources, operations, or structures described herein as a single instance. Additionally, boundaries between various resources, operations, engines, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

Other implementations, uses and advantages of the disclosure will be apparent to those skilled in the art from consideration of the specification and practice of the invention disclosed herein. The specification should be considered exemplary only, and the scope of the invention is accordingly intended to be limited only by the following claims.

What is claimed is:

1. A method comprising:
receiving a first information relating to a measurement of a component to be validated from a first node;
receiving a second information relating to the measurement of the component to be validated from a second node;
determining that the first information matches the second information; and
generating an entry including the first information in a distributed ledger.

2. The method of claim 1, wherein the measurement of the component comprises a deterministic signature of the component.

3. The method of claim 2, wherein the first node comprises a first blockchain node of a blockchain network that stores deterministic signatures of components in the distributed ledger and wherein the second node comprises a second blockchain node of the blockchain network.

4. The method of claim 3, further comprising:
counting a number of nodes, including the first node and the second node, that generated matching information for the measurement of the component.

5. The method of claim 4, further comprising:
apportioning a reward to each of the nodes that generated matching information for the measurement of the component.

6. The method of claim 4, further comprising:
receiving a request to verify a state of the component; and
providing the number in response to the request.

7. The method of claim 3, the method further comprising:
verifying that the first information matches the second information prior to generating the entry in the distributed ledger.

8. The method of claim 7, wherein receiving the first information comprises receiving a proposed blockchain block that includes the first information broadcasted from the first node to the blockchain network for inclusion in the distributed ledger.

9. The method of claim 8, further comprising:
obtaining a smart contract of the blockchain network;
identifying a reward for the first node for generating the blockchain block based on the smart contract; and
causing the reward to be provided to the first node.

10. A system comprising:
a computer system having one or more processors programmed to:
receive a first information relating to a measurement of a component to be validated from a first node;
receive a second information relating to the measurement of the component to be validated from a second node;
determine that the first information matches the second information; and
generate an entry including the first information in a distributed ledger.

11. The system of claim 10, wherein the measurement of the component comprises a deterministic signature of the component.

12. The system of claim 11, wherein the first node comprises a first blockchain node of a blockchain network that stores deterministic signatures of components in the distributed ledger and wherein the second node comprises a second blockchain node of the blockchain network.

13. The system of claim 12, wherein the computer system is further programmed to:
count a number of nodes, including the first node and the second node, that generated matching information for the measurement of the component.

14. The system of claim 13, wherein the computer system is further programmed to:
apportion a reward to each of the nodes that generated matching information for the measurement of the component.

15. The system of claim 14, wherein the computer system is further programmed to:
receive a request to verify a state of the component; and
provide the number in response to the request.

16. The system of claim 12, wherein the computer system is further programmed to:
verify that the first information matches the second information prior to generating the entry in the distributed ledger.

17. The method of claim 16, wherein to receive the first information, the computer system is further programmed to:
receive a proposed blockchain block that includes the first information broadcasted from the first node to the blockchain network for inclusion in the distributed ledger.

18. The system of claim 17, wherein the computer system is further programmed to:
obtain a smart contract of the blockchain network;
identify a reward for the first node for generating the blockchain block based on the smart contract; and
cause the reward to be provided to the first node.

19. A method comprising:
receiving a request from a requester, the request comprising a first information relating to a measurement of a component to be validated;
determining whether the first information matches a content stored in a distributed ledger used to validate a plurality of components including the component;
generating a validation result indicating whether the first information matches the content stored in the distributed ledger; and
providing the validation result to the requester.

20. The method of claim 19, wherein providing the validation result further comprises:
providing a number of verifiers that verified the content stored in the distributed ledger used to validate the plurality of components.
